(19) United States
(12) Patent Application Publication
(10) Pub. No.: US 2012/0082079 A1
(43) Pub. Date: Apr. 5, 2012

(54) DISCONTINUOUS TRANSMISSION (DTX) SIGNALING IN UPLINK DATA CHANNEL

(75) Inventors: Xiliang Luo, Cardiff, CA (US); Peter Gaal, San Diego, CA (US); Juan Montojo, San Diego, CA (US); Wanshi Chen, San Diego, CA (US)

(73) Assignee: QUALCOMM INCORPORATED, San Diego, CA (US)

(21) Appl. No.: 13/251,153

(22) Filed: Sep. 30, 2011

Related U.S. Application Data
(60) Provisional application No. 61/389,640, filed on Oct. 4, 2010.

(51) Int. Cl. H04W 52/02

(52) U.S. Cl. 370/311

(57) ABSTRACT

A method for discontinuous transmission (DTX) signaling in a physical uplink shared channel (PUSCH) of a wireless communication system includes puncturing at least a portion of a physical uplink shared channel (PUSCH) at a location that would collide with acknowledgement (ACK)/negative (ACK/NACK) feedback if ACK/NACK feedback is transmitted. The method also includes transmitting DTX symbols in the punctured portion of the PUSCH by a user equipment (UE). The method further includes detecting DTX symbols on the PUSCH by an evolved Node B (eNodeB), indicating the UE is operating according to a DTX signaling mode.

### CROSS-REFERENCE TO RELATED APPLICATION

This application claims the benefit under 35 U.S.C. §119(e) to United States Provisional Patent Application No. 61/389,640 entitled “DTX SIGNALING IN PUSCH”, filed on Oct. 4, 2010, in the name of Xiliang Luo et al. and assigned to the assignee hereof, the disclosure of which is expressly incorporated by reference herein in its entirety.

### BACKGROUND

1. Field

Aspects of the present disclosure relate generally to wireless communication systems, and more particularly to discontinuous transmission (DTX) signaling in a physical uplink shared channel (PUSCH) of a wireless communication system.

2. Background

Wireless communication networks are widely deployed to provide various communication services such as voice, video, packet data, messaging, broadcast, etc. These wireless networks may be multiple-access networks capable of supporting multiple users by sharing the available network resources. A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibility of interference and/or congested networks grows with more UEs accessing the long-range wireless communication networks and more short-range wireless systems being deployed in communities. Research and development continue to advance Universal Mobile Telecommunication System (UMTS) technologies, not only to meet the growing demand for mobile broadband access, but to advance and enhance the user experience with mobile communications. In certain designs, a need for explicit signaling of downlink discontinuous transmission (DTX) (i.e., UE did not receive any traffic from a base station) within the uplink shared channel may exist for a base station to detect a DTX signal for a UE.

### SUMMARY

According to one aspect of the present disclosure, method for discontinuous transmission (DTX) signaling in a physical uplink shared channel (PUSCH) of a wireless communication system is described. The method includes puncturing at least a portion of a physical uplink shared channel (PUSCH) at a location that would collide with acknowledgement (ACK)/negative (ACK/NACK) feedback if ACK/NACK feedback is transmitted. The method also includes transmitting discontinuous transmission (DTX) symbols in the punctured portion of the PUSCH by a user equipment (UE).

In another aspect, an apparatus for DTX signaling in a PUSCH is described. The apparatus includes at least one processor; and a memory coupled to the at least one processor. The processor(s) is configured to puncture at least a portion of a PUSCH at a location that would collide with ACK/NACK feedback if ACK/NACK feedback is transmitted. The processor(s) is further configured to transmit DTX symbols in the punctured portion of the PUSCH.

In a further aspect, a computer program product for DTX signaling in a PUSCH is described. The computer program product includes a non-transitory computer-readable medium having program code recorded thereon. The computer program product has program code to puncture at least a portion of a PUSCH at a location that would collide with ACK/NACK feedback if ACK/NACK feedback is transmitted. The computer program product has program code further includes program code to transmit DTX symbols in the punctured portion of the PUSCH.

In another aspect, an apparatus for DTX signaling in a PUSCH is described. The apparatus includes means for puncturing at least a portion of a PUSCH at a location that would collide with ACK/NACK feedback if ACK/NACK feedback is transmitted. The apparatus further includes means for transmitting DTX symbols in the punctured portion of the PUSCH.

According to a further aspect of the present disclosure, a method for detecting user equipment (UE) operation according to a discontinuous transmission (DTX) signaling mode is described. The method includes receiving a physical uplink shared channel (PUSCH). The method further includes detecting DTX symbols on the PUSCH, indicating UE operation according to a DTX signaling mode.

In another aspect of the present disclosure, an apparatus for detecting UE operation according to a DTX signaling mode is described. The apparatus includes at least one processor; and a memory coupled to the at least one processor. The processor(s) is configured to receive a PUSCH. The processor(s) is also configured to detect DTX symbols on the PUSCH, indicating UE operation according to a DTX signaling mode.

In a further aspect, a computer program product for detecting UE operation according to a DTX signaling mode is described. The computer program product includes a non-transitory computer-readable medium having program code recorded thereon. The computer program product has program code to receive a PUSCH. The computer program product further includes program code to detect DTX symbols on the PUSCH, indicating UE operation according to a DTX signaling mode.

In another aspect of the present disclosure, an apparatus for detecting UE operation according to a DTX signaling mode is described. The apparatus includes means for receiving a PUSCH. The apparatus further includes means for detecting DTX symbols on the PUSCH, indicating UE operation according to a DTX signaling mode.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a diagram conceptually illustrating an example of a downlink frame structure in a telecommunications system.

FIG. 3 is a block diagram conceptually illustrating an example frame structure in uplink communications.

FIG. 4 is a block diagram conceptually illustrating a design of a base station/eNodeB and a UE configured according to an aspect of the present disclosure.

FIG. 5A is a block diagram conceptually illustrating an example of a transmission in an uplink shared channel without HARQ-ACK feedback according to one aspect of the disclosure.

FIG. 5B is a block diagram conceptually illustrating an example of a transmission in an uplink shared channel with HARQ-ACK feedback according to one aspect of the disclosure.

FIG. 6A is a block diagram conceptually illustrating an example of discontinuous transmission (DTX) signaling in an uplink shared channel without HARQ-ACK feedback according to one aspect of the disclosure.

FIG. 6B is a block diagram conceptually illustrating an example of a transmission in an uplink shared channel with HARQ-ACK feedback according to one aspect of the disclosure.

FIG. 7 is a block diagram illustrating a method for discontinuous transmission (DTX) signaling in a physical uplink shared channel (PUSCH) of a wireless communication system according to one aspect of the disclosure.

FIG. 8 is a block diagram illustrating a method for discontinuous transmission (DTX) signaling in a physical uplink shared channel (PUSCH) of a wireless communication system according to a further aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA) and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like.

The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

A method for wireless communication is provided which includes puncturing at least a portion of a physical uplink shared channel (PUSCH) at a location that would collide with an acknowledgement (ACK)/negative ACK (HACK) (ACK/NACK) feedback if the ACK/NACK feedback is transmitted. The method also includes transmitting discontinuous transmission (DTX) symbols in the punctured portion of the uplink shared channel. In particular, the DTX symbols indicate to the base station that the UE is in a DTX state. The method also includes DTX detection at the eNodeB side. In particular, the eNodeB detects DTX symbols or ACK/NACK symbols on the PUSCH. In one aspect, Radio Resource Control (RRC) signaling enables cell-specific or UE specific DTX signaling. For example, all the UEs served in a particular cell can be configured to explicitly signal DTX in the PUSCH, or just specific UEs can be so configured.

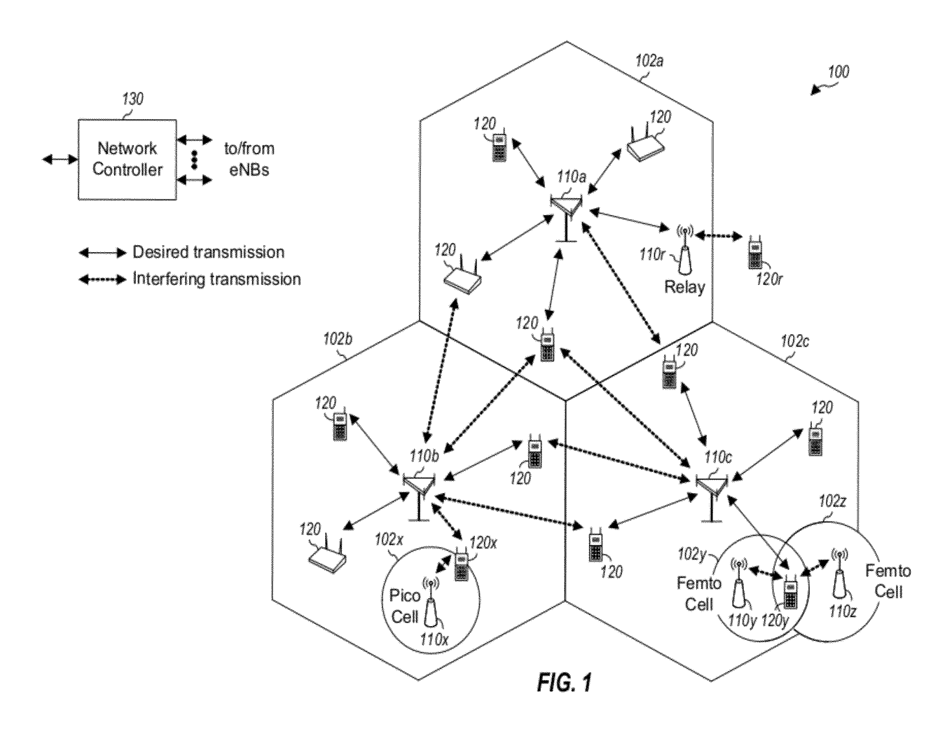

FIG. 1 shows a wireless communication network 100, which may be an LTE-A network, in which detection of discontinuous transmission (DTX) signaling in a physical uplink shared channel (PUSCH) may be implemented. The wireless network 100 includes a number of evolved node Bs (eNodeBs) 110 and other network entities. An eNodeB may be a station that communicates with the UEs and may also be referred to as a base station, a node B, an access point, and the like. Each eNodeB 110 may provide communication coverage for a particular geographic area. In 3GPP, the term “cell” can refer to this particular geographic coverage area of an eNodeB and/or an eNodeB subsystem serving the coverage area, depending on the context in which the term is used.

An eNodeB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNodeB for a macro cell may be referred to as a macro eNodeB. An eNodeB for a pico cell may be referred to as a pico eNodeB. And, an eNodeB for a femto cell may be referred to as a femto eNodeB or a home eNodeB. In the example shown in FIG. 1, the eNodeBs 110a, 110b and 110c are macro eNodeBs for the macro cells 102a, 102b and 102c, respectively. The eNodeB 110x is a pico eNodeB for a pico cell 102x. And, the eNodeBs 110y and 110z are femto eNodeBs for the femto cells 102y and 102z, respectively. An eNodeB may support one or multiple (e.g., two, three, four, and the like) cells.

The wireless network 100 may also include relay stations. A relay station is a station that receives a transmission of data and/or other information from an upstream station (e.g., an eNodeB, UE, etc.) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for either synchronous or asynchronous operations.

In one aspect of the present disclosure, the wireless network 100 may support Frequency Division Duplex (FDD) or Time Division Duplex (TDD) modes of operation. The techniques described herein may be used for FDD or TDD mode of operation.

A network controller 130 may couple to a set of eNodeBs 110 and provide coordination and control for these eNodeBs 110. The network controller 130 may communicate with the eNodeBs 110 via a backhaul. The eNodeBs 110 may also communicate with one another, e.g., directly or indirectly via a wireless backhaul or a wireline backhaul.

The UEs 120 (e.g., UE 120x, UE 120y, etc.) are dispersed throughout the wireless network 100, and each UE may be stationary or mobile. A UE may also be referred to as a terminal, a user terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a net-book, a smart book, or the like. A UE may be able to communicate with macro eNodeBs, pico eNodeBs, femto eNodeBs, relays, and the like. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for a corresponding system bandwidth of 1.25, 2.5, 5, 10 or 20 megahertz (MHz), respectively. The system bandwidth may also be partitioned into sub-bands. For example, a sub-band may cover 1.08 MHz (i.e., 6 resource blocks), and there may be 1, 2, 4, 8 or 16 sub-bands for a corresponding system bandwidth of 1.25, 2.5, 5, 10, 15 or 20 MHz, respectively.

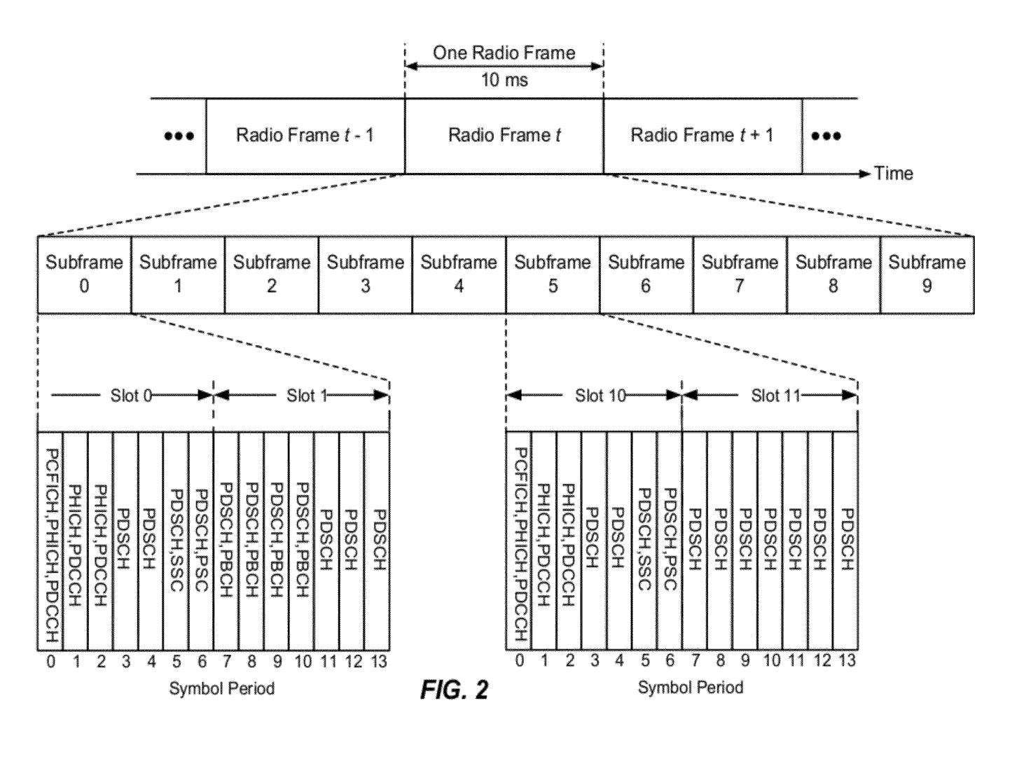

FIG. 2 shows a downlink FDD frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNodeB may send a primary synchronization signal (PSC or PSS) and a secondary synchronization signal (SSC or SSS) for each cell in the eNodeB. For FDD mode of operation, the primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. For FDD mode of operation, the eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in the first symbol period of each subframe, as seen in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support hybrid automatic retransmission (HARQ). The PDCCH may carry information on uplink and downlink resource allocation for UEs and power control information for uplink channels. The eNodeB may send a Physical Downlink Shared Channel (PDSCH) in the remaining symbol periods of each subframe. The PDSCH may carry data for UEs scheduled for data transmission on the downlink.

The eNodeB may send the PSC, SSC and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to groups of UEs in specific portions of the system bandwidth. The eNodeB may send the PSC, SSC, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. For symbols that are used for control channels, the resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 36 or 72 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for all UEs in the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

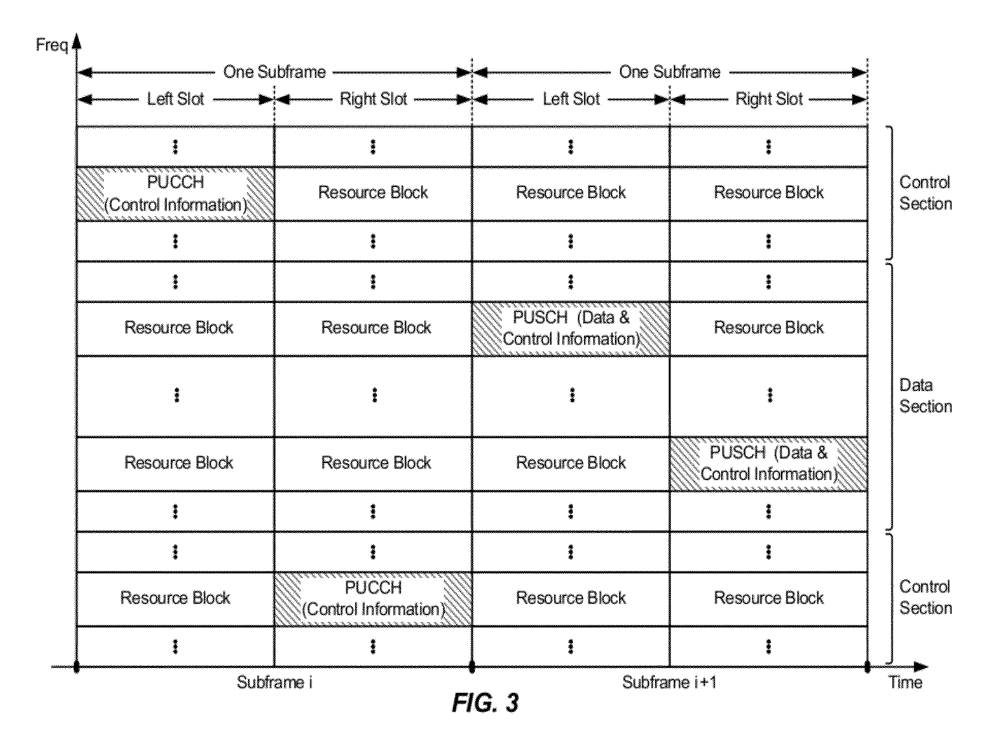

FIG. 3 is a block diagram conceptually illustrating an exemplary FDD and TDD (non-special subframe only) subframe structure in uplink long term evolution (LTE) communications. The available resource blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 3 results in the data section including contiguous subcarriers, which may allow a single UE to be assigned all of the contiguous subcarriers in the data section.

A UE may be assigned resource blocks in the control section to transmit control information to an eNodeB. The UE may also be assigned resource blocks in the data section to transmit data to the eNodeB. The UE may transmit control information in a Physical Uplink Control Channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency as shown in FIG. 3. According to one aspect, in relaxed single carrier operation, parallel channels may be transmitted on the UL resources. For example, a control and a data channel, parallel control channels, and parallel data channels may be transmitted by a UE.

The PSC (primary synchronization carrier), SSC (secondary synchronization carrier), CRS (common reference signal), PBCH, PUCCH, PUSCH, and other such signals and channels used in LTE/-A are described in 3GPP TS 36.211, entitled “Evolved Universal Terrestrial Radio Access (E-UTRA); Physical Channels and Modulation,” which is publicly available.

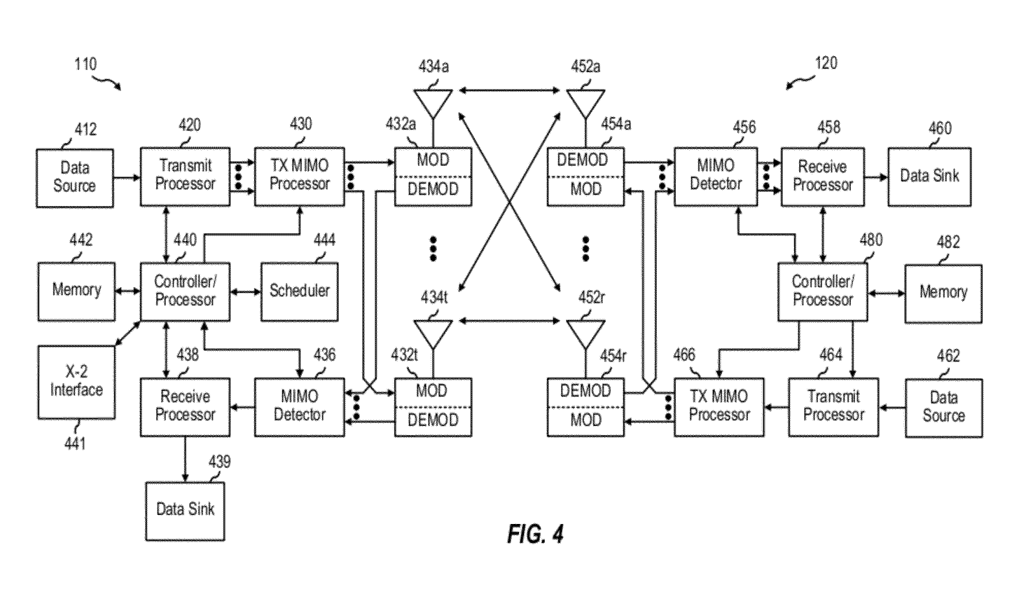

FIG. 4 shows a block diagram of a design of a base station/eNodeB 110 and a UE 120, which may be one of the base stations/eNodeBs and one of the UEs in FIG. 1. For example, the base station 110 may be the macro eNodeB 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the PBCH, PCFICH, PHICH, PDCCH, etc. The data may be for the PDSCH, etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the PUSCH) from a data source 462 and control information (e.g., for the PUCCH) from the controller/processor 480. The processor 464 may also generate reference symbols for a reference signal. The symbols from the transmit processor 464 may be precoded by a TX MIMO processor 466 if applicable, further processed by the modulators 454a through 454r (e.g., for SC-FDM, etc.), and transmitted to the base station 110. At the base station 110, the uplink signals from the UE 120 may be received by the antennas 434, processed by the demodulators 432, detected by a MIMO detector 436 if applicable, and further processed by a receive processor 438 to obtain decoded data and control information sent by the UE 120. The processor 438 may provide the decoded data to a data sink 439 and the decoded control information to the controller/processor 440. The base station 110 can send messages to other base stations, for example, over an X2 interface 441.

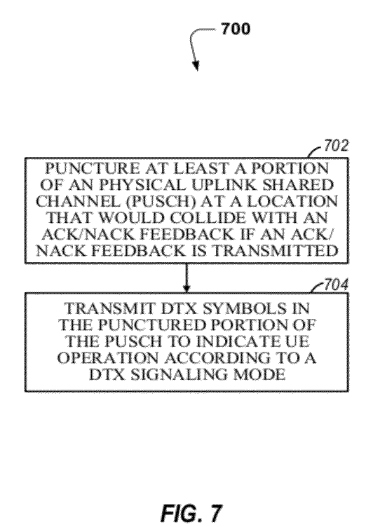

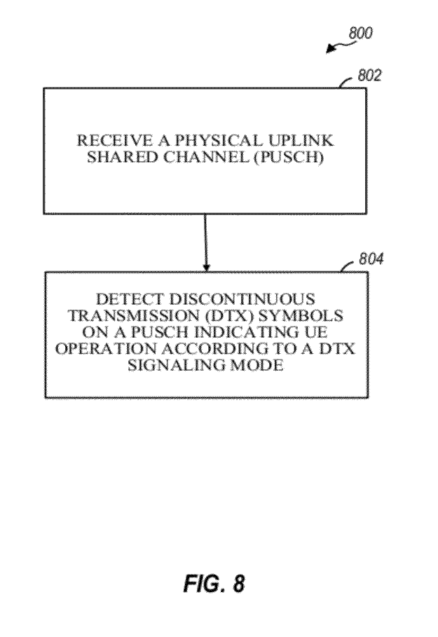

The controllers/processors 440 and 480 may direct the operation at the base station 110 and the UE 120, respectively. The processor 440 and/or other processors and modules at the base station 110 may perform or direct the execution of the functional blocks illustrated in method flow chart FIG. 8, and/or various processes for the techniques described herein. The processor 480 and/or other processors and modules at the UE 120 may also perform or direct the execution of the functional blocks illustrated in method flow chart FIG. 7, and/or other processes for the techniques described herein. The memories 442 and 482 may store data and program codes for the base station 110 and the UE 120, respectively. A scheduler 444 may schedule UEs for data transmission on the downlink and/or uplink. In one aspect of the present disclosure, the UE 120 is configured to transmit discontinuous transmission (DTX) symbols in a punctured portion of a PUSCH that would collide with an ACK/NACK feedback if an ACK/NACK feedback is transmitted.

There exists a present need to explicitly signal downlink discontinuous transmission (DTX) in an uplink data channel (e.g., PUSCH) to enhance DTX detection at the base station. In LTE and LTE-A, for PUSCH transmission, Hybrid Automatic Repeat reQuest (ARQ)-ACK (HARQ-ACK) feedback for a corresponding PDSCH (downlink transmission) may be multiplexed with PUSCH. Hybrid automatic repeat request (HARD) is used in LTE for PDSCH and PUSCH operation. When a packet is received correctly, a positive acknowledgement (ACK) is sent to the transmitter. When a packet cannot be received correctly, a negative acknowledgement (NACK) is sent to the transmitter to request a retransmission of the same packet. Such a process continues until the packet is received correctly or the number of retransmissions reaches a pre-defined limit. As described herein, DTX may mean that the UE does not detect any scheduled PDSCH from the eNodeB in the downlink, where the eNodeB is expecting, for example, an ACK/NACK or DTX feedback from the UE.

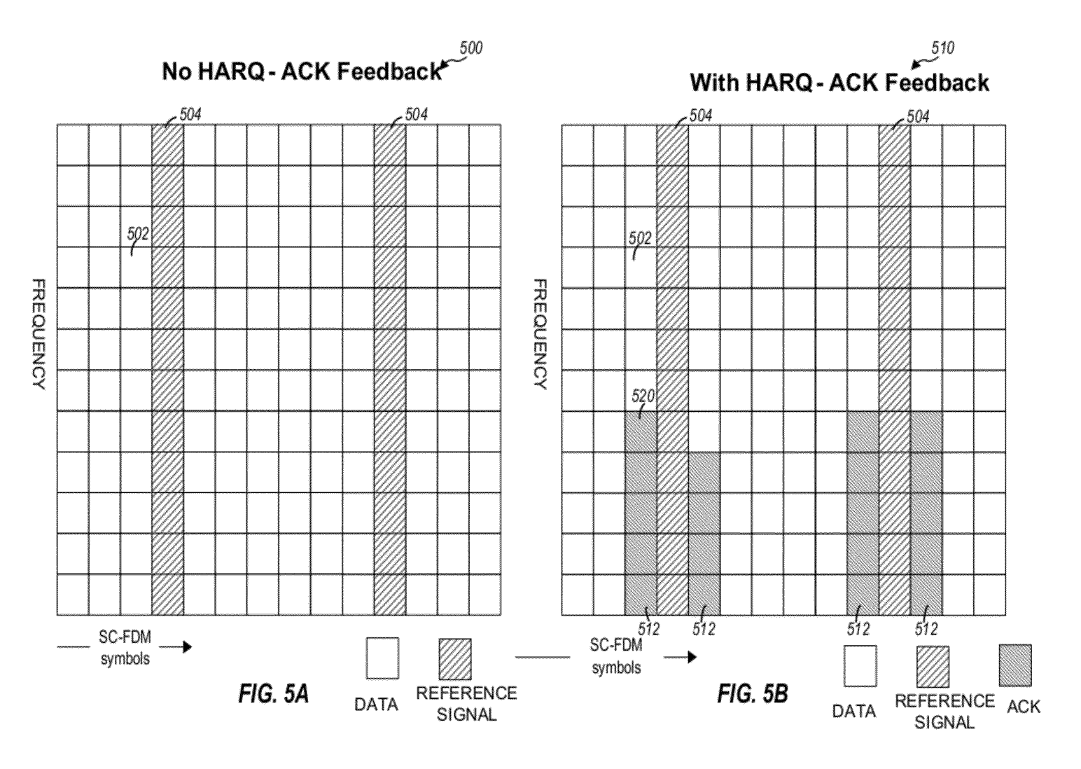

FIG. 5A shows an example transmission in a physical uplink shared channel (PUSCH) 500 without HARQ-ACK feedback. The depicted physical uplink shared channel 500 illustrates two time slots of a subframe. Representatively, the physical uplink shared channel 500 includes data 502 multiplexed with a demodulation reference signals (RS) 504 in a time domain. As shown in FIG. 5A, the PUSCH channel 500 does not include any ACK/NACK feedback.

FIG. 5B shows an example transmission in a physical uplink shared channel (PUSCH) 510 with HARQ-ACK feedback 520 for enabling proper operation on a downlink channel (e.g., PDSCH). The physical uplink shared channel or PUSCH 510 includes data 502 multiplexed with a demodulation reference signal (RS) 504 in a time domain. Representatively, HARQ-ACK coded modulation symbols (e.g., ACK/NACK feedback) 520 puncture the PUSCH modulation symbols (data) 502. As noted above, HARQ-ACK feedback is related to a corresponding downlink transmission (e.g., the PDSCH). As shown in FIG. 5B, the punctured portions 512 of the physical uplink shared channel 510 are adjacent the reference signal 504 because having channel estimates that are closer to the reference signal 504 is generally desired. The number of punctured resource elements (REs) depends on the number of ACK/NACK bits fed back to the eNodeB (e.g., a 2-bit ACK/NACK codeword) and the current uplink channel quality.

There may be situations where an eNodeB expects an ACK/NACK in response to a PDSCH transmission. In these situations, when the UE misses that PDSCH transmission due to, e.g., deep channel fade, the absence of a UE ACK/NACK response may be referred to as discontinuous transmission or DTX. At the eNodeB side, a DTX detection may be performed to distinguish between the following two hypotheses because the eNodeB does not know whether the UE misses that PDSCH transmission:

Hypothesis 0 (H0): DTX—the PUSCH is not punctured with HARQ-ACK symbols, as shown in the PUSCH 500 of FIG. 5A because the UE is in a DTX signaling mode. During normal operation, the UE does not transmit any ACK/NACKs in situations where: (a) no PDSCH data is scheduled for the UE; or (b) the UE missed a downlink grant from the eNodeB. In these situations, no knowledge of the data symbols can be assumed by the eNodeB as part of the ACK/NACK detection. In other words, the ACK/NACK is decoded by the eNodeB regardless of whether the data is decoded.

Hypothesis 1 (H1): No-DTX—PUSCH is punctured with HARQ-ACK coded modulation symbols, as shown in the PUSCH 510 of FIG. 5B. In this configuration, the UE is operating in a normal operation (non-DTX) mode and feeds back an ACK/NACK status for a corresponding PDSCH transmission.

In the case of hypothesis 0 (H0), the eNodeB treats any modulation symbols that would have been punctured by a HARQ-ACK if hypothesis 1 (H1) were true as random modulation symbols. In LTE, the PUSCH is typically targeted to have approximately a ten percent (10%) block error rate (BLER) for the initial transmission. In addition, HARQ-ACK feedback is typically targeted to have a bit error rate (BER) of approximately one-tenth of one-percent (0.1%). Thus, during DTX detection, the eNodeB cannot assume the PUSCH is properly decoded. Therefore, one aspect of the present disclosure provides a UE side implementation for improving DTX detection performance at the eNodeB.

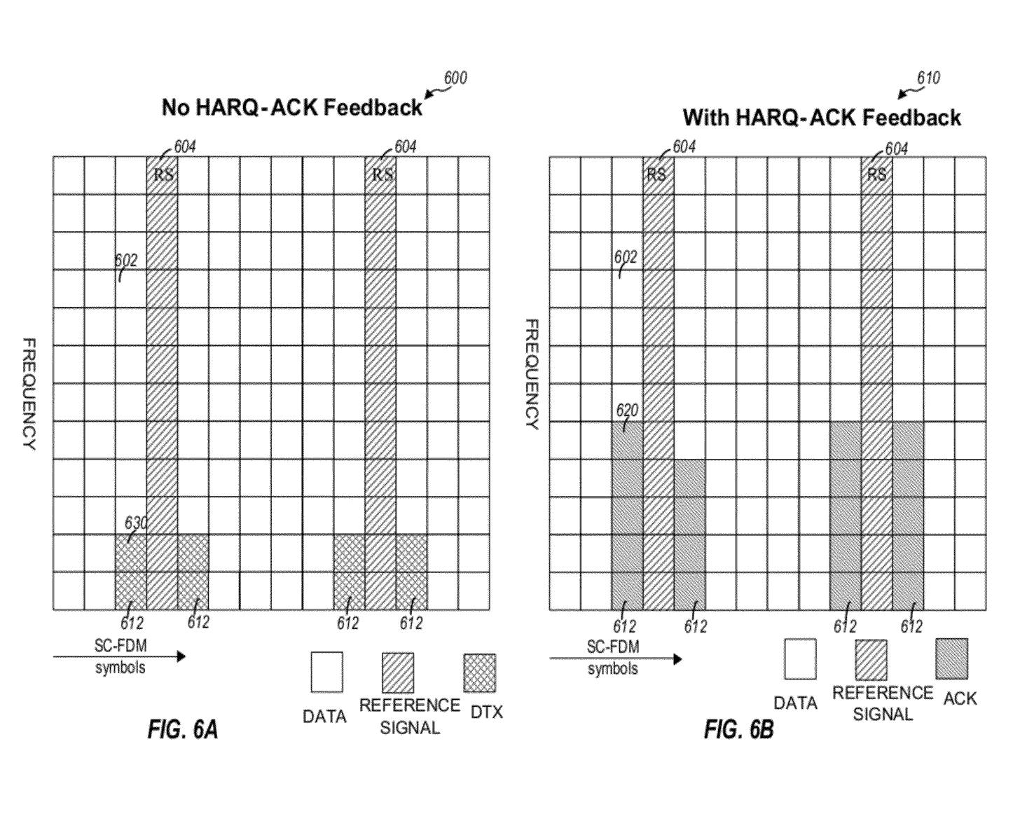

FIG. 6A depicts an example of discontinuous transmission (DTX) signaling in a physical uplink shared channel (PUSCH) 600 without HARQ-ACK feedback for improving the DTX detection performance of an eNodeB, according to one aspect of the present disclosure. Representatively, the physical uplink shared channel (PUSCH) 600 shows two time slots of a subframe. The physical uplink shared channel 600 includes data 602 multiplexed with a demodulation reference signal (RS) 604 in a time domain manner. The PUSCH channel 600, however, does not include any ACK/NACK feedback. Rather portions 612 of the physical uplink shared channel 600 are punctured in a substantially similar manner as is performed when puncturing for communicating ACK/NACK feedback.

In this aspect of the present disclosure, the resource elements adjacent the reference signals 604 are punctured for explicit DTX signaling. Accordingly, DTX coded modulation symbols 630 puncture the physical uplink shared channel 600 in the same place where HARQ-ACK coded modulation symbols would puncture the physical uplink shared channel. In other words, the PUSCH 600 is punctured at locations that would collide with ACK/NACK feedback if ACK/NACK feedback is transmitted. In one configuration, the DTX signaling pattern is selected as substantially distinct from an ACK/NACK signaling pattern to further assist the eNodeB in distinguishing between DTX signaling patterns and ACK/NACK feedback symbols.

FIG. 6B depicts an example transmission in a physical uplink shared channel (PUSCH) 610 with HARQ-ACK feedback according to a further aspect of the present disclosure. Representatively, the HARQ-ACK coded modulation symbols 620 puncture portions 612 of the PUSCH 610 adjacent to the demodulation reference signal 604. The number of resource elements punctured 612 will depend on the number of ACK/NACK bits fed-back to the eNodeB and the spectral efficiency of the current uplink shared data channel.

Referring to the PUSCH 600 and 610 shown in FIGS. 6A and 6B, respectively, DTX detection at the eNB side may be performed to distinguish the following two hypotheses:

Hypothesis 0 (H0): DTX—PUSCH is punctured with DTX coded modulation symbols 630, as shown by the PUSCH 600 of FIG. 6A. In this aspect of the present disclosure, the DTX coded modulation symbols 630 inform the eNodeB that the UE did not detect any scheduled PDSCH. As indicated above, the UE may operate in a DTX signaling mode when no data is scheduled for the UE or when the UE missed a downlink grant from the eNodeB.

Hypothesis 1 (H1): No-DTX—the PUSCH is punctured with HARQ-ACK coded modulation symbols 620, as shown by the PUSCH 610 of FIG. 6B.

In case of hypothesis 0 (H0), the eNodeB knows the true value of the modulation symbols punctured by the DTX symbols 630. In other words, these punctured modulation symbols are not random modulation symbols as was illustrated in FIG. 5A. In this way, DTX detection performance at the eNodeB can be improved. In particular, the DTX detection is improved because the eNodeB knows what the UE is transmitting in each of hypotheses described above (e.g., H0/H1).

In a further aspect of the present disclosure, upper layer radio resource control (RRC) signaling (e.g., higher layer signaling) enables DTX signaling in the PUSCH. The following upper layer signaling configurations are discussed, although other implementations may also enable the DTX signaling:

Option 1: Cell-specific Enabling. In this configuration, each of the UEs served in a particular cell will be signaled to explicitly signal a DTX signal mode in the PUSCH.

Option 2: UE-specific Enabling. In this configuration, an upper layer radio resource control (RRC) signaling (e.g., higher layer signaling) configures whether a UE will perform explicit DTX signaling depending on the particular operating scenario of that UE. The operating scenarios may include, but are not limited to, a downlink geometry, a transmission mode on the downlink and/or uplink, a carrier aggregation status, a traffic pattern (e.g., large amounts of data or sparse data), and the like.

The overhead introduced by the explicit DTX signaling is insignificant. In the case of heavy downlink traffic, the additional overhead caused by any DTX coded symbols is small because the UE will frequently operate in a non-DTX mode. In the case of light downlink traffic, if the uplink traffic is also light, the additional overhead caused by DTX coded symbols is small because ACK/NACK symbols are typically fed back via a control channel (e.g., Physical Uplink Control Channel (PUCCH)) instead of a data channel (e.g., PUSCH.) Further, UE-specific enabling of DTX signaling on the PUSCH reduces an amount of additional overhead from the system's point of view because not all UEs will be explicitly signaling DTX.

In one configuration, the number of coded modulation symbols for communicating according to the DTX mode is determined in a similar manner as 1-bit HARQ-ACK. As a result, the number of resource elements punctured for DTX signaling may be different when compared to HARQ-ACK signaling, for example, as illustrated in FIGS. 6A and 6B. Nevertheless, some overlapping between the punctured for DTX signaling and the portions that would have been punctured for HARQ-ACK signaling will exist in configuration where the DTX and HARQ-ACK signaling are performed in a substantially similar manner.

FIG. 7 is a flow chart of a process 700 for wireless communication. The process 700 begins at block 702 in which at least a portion of an of a physical uplink shared channel (PUSCH) is punctured at a location that would collide with ACK/NACK feedback if ACK/NACK feedback is transmitted. In one configuration, the uplink channel is punctured in a substantially similar manner as is performed when puncturing for ACK/NACK feedback. The process 700 continues at block 704 in which DTX coded modulation symbols are transmitted in the punctured portion of the physical uplink shared channel. For example, as shown in FIG. 6A, DTX coded modulation symbols are associated with non-ACK/NACK feedback to indicate UE operation according to a DTX signaling mode.

FIG. 8 is a flow chart of another process 800 for wireless communication. The process 800 begins with block 802 in which a signal on a physical uplink shared channel is received. The process 800 continues at block 804 in which discontinuous transmission (DTX) symbols or ACK/NACK symbols are detected on the PUSCH. For example, non-ACK/NACK feedback signal is received in a portion of a physical uplink shared channel. In one aspect, the portion of the PUSCH is punctured in a substantially similar manner as is performed when puncturing for ACK/NACK feedback. For example, the PUSCH is punctured at a location that would collide with ACK/NACK feedback if ACK/NACK feedback is transmitted, as shown in FIG. 6A. In one aspect, the eNodeB knowledge of DTX coded modulation symbols enables a non-ACK/NACK feedback signal to be properly decoded.

In one configuration, the eNodeB 110 is configured for wireless communication including means for detecting discontinuous transmission (DTX) symbols or ACK/NACK symbols on a physical uplink shared channel (PUSCH), indicating user equipment (UE) operation according to a DTX signaling mode. In one aspect, the detection means may be the controller processor 440, the memory 442, the receive processor 438, demodulators 432a-t, and/or antenna 434a-t of FIG. 4 configured to perform the functions recited by the detection means. In another aspect, the aforementioned means may be a module or any apparatus configured to perform the functions recited by the aforementioned means.

In one configuration, the UE 120 is configured for wireless communication including means for puncturing at least a portion of a physical uplink shared channel (PUSCH) at a location that would collide with acknowledgement (ACK)/negative ACK (NACK) (ACK/NACK) feedback if ACK/NACK feedback is transmitted. In one aspect, the puncturing means may be the controller processor 480, the memory 482, the transmit processor 464, the de/modulators 454a-r and/or the antennas 452a-452r configured to perform the functions recited by the puncture means. The UE 120 is also configured to include a means for transmitting discontinuous transmission (DTX) symbols in the punctured portion of the PUSCH for indicating that the UE is operating according to a DTX signaling mode. In one aspect, this transmit means may be the controller/processor 480, the memory 482, the transmit processor 464, the de/modulators 454a-r and/or the antennas 452a-452r configured to perform the functions recited by the transmit means. In another aspect, the aforementioned means may be a module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
puncturing at least a portion of a physical uplink shared channel (PUSCH) at a location that would collide with acknowledgement (ACK)/negative (ACK/NACK) feedback if an ACK/NACK feedback is transmitted; and
transmitting discontinuous transmission (DTX) symbols in the punctured portion of the PUSCH.

2. The method of claim 1, in which puncturing includes puncturing resource elements adjacent to a demodulation reference signal.

3. The method of claim 1, further including receiving upper layer signaling that enables cell-specific DTX signaling such that all user equipments (UEs) served in a particular cell explicitly signal DTX symbols in the PUSCH.

4. The method of claim 1, further including receiving upper layer signaling that enables UE-specific DTX signaling such that a particular UE explicitly signals DTX symbols in the PUSCH.

5. An apparatus configured for operation in a wireless communication network, the apparatus comprising:
a memory; and
at least one processor coupled to the memory, the at least one processor being configured:
to puncture at least a portion of a physical uplink shared channel (PUSCH) at a location that would collide with acknowledgement (ACK)/negative (ACK/NACK) feedback if ACK/NACK feedback is transmitted; and
to transmit discontinuous transmission (DTX) symbols in the punctured portion of the PUSCH.

6. The apparatus of claim 5, in which the processor is further configured to puncture at least the portion of the PUSCH by puncturing resource elements adjacent to a demodulation reference signal.

7. The apparatus of claim 5, in which the processor is further configured to receive upper layer signaling that enables cell-specific DTX signaling such that all user equipments (UEs) served in a particular cell explicitly signal DTX symbols in the PUSCH.

8. The apparatus of claim 5, in which the processor is further configured to receive upper layer signaling that enables UE-specific DTX signaling such that a particular UE explicitly signals DTX symbols in the PUSCH.

9. A computer program product configured for wireless communication, the computer program product comprising:
a non-transitory computer-readable medium having non-transitory program code recorded thereon, the program code comprising:
program code to puncture at least a portion of a physical uplink shared channel (PUSCH) at a location that would collide with acknowledgement (ACK)/negative (ACK/NACK) feedback if ACK/NACK feedback is transmitted; and
program code to transmit discontinuous transmission (DTX) symbols in the punctured portion of the PUSCH.

10. An apparatus for wireless communication, the apparatus comprising:
means for puncturing at least a portion of a physical uplink shared channel (PUSCH) at a location that would collide with acknowledgement (ACK)/negative (ACK/NACK) feedback if ACK/NACK feedback is transmitted; and
means for transmitting discontinuous transmission (DTX) symbols in the punctured portion of the PUSCH.

11. A method of wireless communication, comprising:
receiving a physical uplink shared channel (PUSCH); and
detecting discontinuous transmission (DTX) symbols on the PUSCH, indicating user equipment (UE) operation according to a DTX signaling mode.

12. The method of claim 11, in which the DTX symbols are received at a location of the PUSCH that would collide with acknowledgement (ACK)/negative ACK (NACK) feedback if ACK/NACK feedback is received.

13. The method of claim 11, further including:
analyzing at least one punctured portion of the PUSCH in which ACK/NACK feedback is expected; and
detecting UE operation in the DTX signaling mode if a DTX coded modulation symbol is detected within the at least one punctured portion of the PUSCH.

14. The method of claim 11, further including transmitting an upper layer signal that enables cell-specific DTX signaling such that all UEs served in a particular cell explicitly signal DTX symbols in the PUSCH.

15. The method of claim 11, further including transmitting an upper layer signal that enables UE-specific DTX signaling such that a particular UE explicitly signals DTX symbols in the PUSCH.

16. The method of claim 15, in which the upper layer signal includes a radio resource control (RRC) signal.

17. An apparatus configured for operation in a wireless communication network, the apparatus comprising:
a memory; and
at least one processor coupled to the memory, the at least one processor being configured:
to receive a physical uplink shared channel (PUSCH); and
to detect discontinuous transmission (DTX) symbols on the PUSCH, indicating user equipment (UE) operation according to a DTX signaling mode.

18. The apparatus of claim 17, in which the DTX symbols are received at a location of the PUSCH that would collide with acknowledgement (ACK)/negative ACK (NACK) feedback if ACK/NACK feedback is received.

19. The apparatus of claim 17, in which the processor is further configured:
to analyze at least one punctured portion of the PUSCH in which ACK/NACK feedback is expected; and
to detect UE operation in the DTX signaling mode if a DTX coded modulation symbol is detected within the at least one punctured portion of the PUSCH.

20. The method of claim 17, in which the processor is further configured to transmit an upper layer signal that enables cell-specific DTX signaling such that all UEs served in a particular cell explicitly signal DTX symbols in the PUSCH.

21. The method of claim 17, further including transmitting an upper layer signal that enables UE-specific DTX signaling such that a particular UE explicitly signals DTX symbols in the PUSCH.

22. The method of claim 21, in which the upper layer signal includes a radio resource control (RRC) signal.

23. A computer program product configured for wireless communication, the computer program product comprising:
a non-transitory computer-readable medium having non-transitory program code recorded thereon, the program code comprising:
program code to receive a physical uplink shared channel (PUSCH); and
program code to detect discontinuous transmission (DTX) symbols on the PUSCH, indicating user equipment (UE) operation according to a DTX signaling mode.

24. An apparatus for wireless communication, the apparatus comprising:
means for receiving a physical uplink shared channel (PUSCH); and
means for detecting discontinuous transmission (DTX) symbols on the PUSCH, indicating user equipment (UE) operation according to a DTX signaling mode.
